(19) United States
(12) Patent Application Publication
(10) Pub. No.: US 2018/0368637 A1
(43) Pub. Date: Dec. 27, 2018

(54) DIRT SEPARATOR AND VACUUM CLEANER

(71) Applicant: Dyson Technology Limited, Wiltshire (GB)

(72) Inventors: Peter David GAMMACK, Gloucester (GB); Thomas George Anthony CALDWELL, London (GB)

(73) Assignee: Dyson Technology Limited, Wiltshire (GB)

(21) Appl. No.: 16/016,048

(22) Filed: Jun. 22, 2018

(30) Foreign Application Priority Data
Jun. 23, 2017 (GB) 1710067.8

(51) Int. Cl. A47L 9/16; B04C 5/185; B04C 5/26; B04C 5/28; B04C 9/00; B01D 46/00; B01D 50/00; A47L 9/20

(52) U.S. Cl. CPC A47L 9/1608; B04C 5/185; B04C 5/26; B04C 5/28; B04C 9/00; B01D 46/0065; B01D 2279/55; A47L 9/1625; A47L 9/1683; A47L 9/1666; A47L 9/20; B04C 2009/004; B01D 50/002

(57) ABSTRACT

A dirt separator for a vacuum cleaner includes a first separation stage having a first dirt collection chamber for storing dirt removed by the first separation stage; and a second separation stage positioned downstream of the first separation stage, the second separation stage having a second dirt collection chamber for storing dirt removed by the second separation stage. The first and second dirt collection chambers are movable relative to one another between first and second positions. A guide feature provided on a sidewall of the second dirt collection chamber the guide feature being configured to guide movement of the first and second dirt collection chambers relative to one another between the first and second positions.

### REFERENCE TO RELATED APPLICATIONS

This application claims the priority of United Kingdom Application No. 1710067.8, filed Jun. 23, 2017, the entire contents of which are incorporated herein by reference.

### FIELD OF THE INVENTION

The present invention relates to a dirt separator of the type that can be used on a vacuum cleaner, and a vacuum cleaner comprising such a dirt separator.

The invention is not limited to dirt separators for any particular type of vacuum cleaner. For example, it includes dirt separators for upright vacuum cleaners and dirt separators for cylinder vacuum cleaners or handheld vacuum cleaners.

### BACKGROUND OF THE INVENTION

Some known dirt separators are arranged so that different parts thereof can be moved relative to one another, for instance so as to perform a shroud wiping operation. Some of these have a guide feature which guides the relative movement of those components. However, the provision of these guide features can place design constraints on the dirt separator as a whole. For instance, other components of the separator may need to be repositioned or shrunk down so as to provide space for the guide features. Furthermore, the guide features may be vulnerable to ingress of dirt from a dirt collection chamber of the separator.

### SUMMARY OF THE INVENTION

It is an object of the invention to mitigate or obviate at least one of the above disadvantages, and/or to provide an improved or alternative dirt separator or vacuum cleaner.

According to a first aspect of the present invention there is provided a dirt separator for a vacuum cleaner, the dirt separator comprising a first separation stage having a first dirt collection chamber for storing dirt removed by the first separation stage; a second separation stage positioned downstream of the first separation stage, the second separation stage having a second dirt collection chamber for storing dirt removed by the second separation stage, wherein the first and second dirt collection chambers are movable relative to one another between first and second positions; and a guide feature provided on a sidewall of the second dirt collection chamber the guide feature being configured to guide movement of the first and second dirt collection chambers relative to one another between the first and second positions.

The space which the dirt separator can occupy on a vacuum cleaner is often limited (for instance so that the vacuum cleaner as a whole is sufficiently compact and/or aesthetically proportioned), and positioning the guide feature on a sidewall of the second dirt collection chamber can reduce its impact on the size and position of other components. In contrast, in a dirt separator in which the overall diameter is limited for compactness or aesthetic reasons, if the guide feature was provided on a wall of the first dirt collection chamber which defines a outer periphery of the dirt separator, the associated part of the first dirt collection chamber wall would need to be moved radially inwards to compensate. This, in turn, would reduce the capacity of the first dirt collection chamber.

Alternatively or in addition, providing the guide feature on a sidewall of the second dirt collection chamber may reduce the total number of component parts of the dirt separator (and therefore reduce production cost and/or assembly time) in comparison to an arrangement where the guide feature is provided on a dedicated support structure.

Two guide features may be provided on one or more sidewalls of the second dirt collection chamber.

The provision of two guide features rather than one may improve the stability with which movement of the dirt collection chambers is guided, in contrast to an arrangement where a single guide feature provides guiding support at a single location. Both guide features being provided on a sidewall or sidewalls of the second dirt collection chamber may further reduce their impact on the size and position of other components of the separator, as discussed above.

The or each guide feature may be, for example, a rail or track, or a runner configured to pass along a rail or track.

Said two guide features may be provided on different sidewalls of the second dirt collection chamber.

This may space the two guide features apart, which in turn can spread the guiding support offered by the guide features and thereby further increase the stability of movement of the dirt collection chambers.

As an alternative, the two guide features may be provided on the same sidewall of the dirt collection chamber. In this case, the guide features may nonetheless be positioned sufficiently far apart on said sidewall for sufficient stability to be provided.

The two guide features may be positioned on opposite sides of the second dirt collection chamber.

The guide features being spaced apart in this way may further increase the stability with which movement of the dirt collection chambers is guided.

As an example, where the two guide features are provided on different sidewalls, the second dirt collection chamber may be generally cuboidal and the guide features may be provided on opposite sidewalls. As another example, where the two guide features are provided on the same sidewall, the dirt collection chamber may have a single generally cylindrical sidewall and the guide features may be provided at generally diametrically opposite points around that sidewall.

The first separation stage may define a longitudinal axis, and the two guide features may be positioned generally opposite to one another in the circumferential direction relative to the longitudinal axis.

The or each guide feature may be provided on an outer surface of said sidewall.

This may reduce the possibility of dirt contained in the second dirt collection chamber from interfering with the function of the guide feature (for instance clogging a guide feature in the form of a recessed track).

The or each guide feature may contact the first dirt collection chamber.

This may simplify the design of the dirt separator, and/or reduce the number of component parts thereof (which, in turn, may reduce assembly time or production cost), in contrast to an arrangement where the guide member contacts a stand-alone component which is mounted to the first dirt collection chamber.

The first dirt collection chamber may define at least one complementary feature, the or each complementary feature co-operating with the or each guide feature to guide said movement of the first and second dirt collection chambers.

The or each guide feature engaging with a complementary guide feature provided by the first dirt collection chamber may improve the performance of said guidance. For instance, it may increase strength or stability or reduce frictional resistance (for instance where the guide feature is a rail and is received in a complementary feature in the form of a track or a runner, rather than bearing on a planar surface).

The first and second dirt collection chambers may be detachable from one another by moving them beyond the second position from the first position.

This can allow a user to separate the dirt collection chambers for cleaning or servicing, or to replace one of the dirt collection chambers without also having to replace the other. The dirt collection chambers being separable by moving them beyond the second position may be an advantageously quick, simple or intuitive process for the user.

The dirt separator may further comprise a pair of stop surfaces which are arranged to abut when the first and second dirt collection chambers are in the second position so as to prevent them moving from the first position beyond the second position.

The dirt collection chambers being prevented from moving beyond the second position can make the dirt separator move user-friendly—a user can simply move the dirt collection chambers from the first position towards the second position, and the dirt collection chambers will stop moving once they have reached the second position. In the absence of stop surfaces the user may have to judge when the dirt collection chambers have reached the second position and stop at that point.

One of said stop surfaces may be provided on a sidewall of the second dirt collection chamber.

Providing one of the stop surfaces on a sidewall of the second dirt collection chamber may reduce the stop surface's impact on the size and position of other components of the separator, and/or reduce the total number of component parts of the dirt separator, for the same reasons as discussed above in relation to the guide feature(s) being provided on a sidewall of the second dirt collection chamber.

One of said stop surfaces may be selectively movable out of engagement with the other of said stop surfaces so as to allow said movement of the first and second dirt collection chambers beyond the second position.

This can provide the user-friendliness discussed above, where the first and second dirt collection chambers stop when they reach the second position, while nonetheless allowing the dirt collection chambers to be moved beyond the second position if this is actively desired (for instance where this detaches the dirt collection chambers from one another as discussed above).

According to a second aspect of the present invention there is provided a vacuum cleaner comprising a dirt separator according to any preceding claim.

This may provide a vacuum cleaner which provides one or more of the advantages discussed above.

According to a first arrangement useful for understanding the invention there is provided a dirt separator for a vacuum cleaner, the dirt separator comprising a first separation stage having a first dirt collection chamber for storing dirt removed by the first separation stage; a second separation stage positioned downstream of the first separation stage, the second separation stage having a second dirt collection chamber for storing dirt removed by the second separation stage; a lid movable between closed and open positions to selectively block and unblock an emptying aperture provided in the first dirt collection chamber; and a latch mechanism movable between securing and releasing configurations, wherein the first and second dirt collection chambers are movable relative to one another between first and second positions; the latch mechanism is configured to secure the first and second dirt collection chambers in the first position, and to secure the lid in the closed position, when the latch mechanism is in the in the securing configuration; and the latch mechanism is secured to allow the first and second dirt collection chambers to move towards the second position, and to allow the lid to move towards the open position, when the latch mechanism is in the releasing configuration.

The latch mechanism being configured to secure and release both the dirt collection chambers and the lid avoids the need for two latch mechanisms (one for securing and releasing the dirt collection chambers and one for securing and releasing the lid). This, in turn can make the separator stage easier to use, since a user need only operate a single catch, and/or can reduce the number of components of the dirt separator and thereby make it easier or cheaper to produce.

At least part of the latch mechanism may be provided on a sidewall of the second dirt collection chamber.

The space which the dirt separator can occupy on a vacuum cleaner is often limited (for instance so that the vacuum cleaner as a whole is sufficiently compact and/or aesthetically proportioned), and positioning part of the latch mechanism on a sidewall of the second dirt collection chamber can reduce the impact of the latch mechanism on the size and position of other components. In contrast, in a dirt separator in which the overall diameter is limited for compactness or aesthetic reasons, if the latch mechanism was provided on a wall of the first dirt collection chamber which defines a outer periphery of the dirt separator, the associated part of the first dirt collection chamber wall would need to be moved radially inwards to compensate. This, in turn, would reduce the capacity of the first dirt collection chamber.

Alternatively or in addition, providing at least part of the latch mechanism on a sidewall of the second dirt collection chamber may reduce the total number of component parts of the dirt separator (and therefore reduce production cost and/or assembly time) in comparison to an arrangement where the latch mechanism is provided on a dedicated latch support structure.

Said at least part of the latch mechanism may be provided on an outer surface of said sidewall.

This can avoid dirt contained inside the second dirt collection chamber from clogging or otherwise interfering with the latch mechanism, for instance in contrast to an arrangement in which part of the latch mechanism was provided on an inner surface of the second dirt collection chamber.

Said at least part of the latch mechanism may include a moving part of the latch mechanism.

The separator may further comprise a shield configured to cover a portion or substantially all of said at least part of the latch mechanism.

Substantially all of the latch mechanism may be provided on said outer surface.

According to a second arrangement useful for understanding the invention there is provided a dirt separator for a vacuum cleaner, the dirt separator comprising a first separation stage having a first dirt collection chamber for storing dirt removed by the first separation stage; a second separation stage positioned downstream of the first separation stage, the second separation stage having a second dirt collection chamber for storing dirt removed by the second separation stage; and a selectively-releasable latch mechanism, wherein at least part of the latch mechanism is provided on an outer surface of a sidewall of the second dirt collection chamber.

The space which the dirt separator can occupy on a vacuum cleaner is often limited (for instance so that the vacuum cleaner as a whole is sufficiently compact and/or aesthetically proportioned), and positioning part of the latch mechanism on a sidewall of the second dirt collection chamber can reduce the impact of the latch mechanism on the size and position of other components. In contrast, in a dirt separator in which the overall diameter is limited for compactness or aesthetic reasons, if the latch mechanism was provided on a wall of the first dirt collection chamber which defines a outer periphery of the dirt separator, the associated part of the first dirt collection chamber wall would need to be moved radially inwards to compensate. This, in turn, would reduce the capacity of the first dirt collection chamber.

Alternatively or in addition, providing at least part of the latch mechanism on a sidewall of the second dirt collection chamber may reduce the total number of component parts of the dirt separator (and therefore reduce production cost and/or assembly time) in comparison to an arrangement where the latch mechanism is provided on a dedicated latch support structure.

At least part of the latch mechanism being provided on an outer surface of the second dirt collection chamber can avoid dirt contained inside the second dirt collection chamber from clogging or otherwise interfering with the latch mechanism, for instance in contrast to an arrangement in which part of the latch mechanism was provided on an inner surface of the second dirt collection chamber.

Said at least part of the latch mechanism may include a moving part of the latch mechanism.

The separator may further comprise a shield configured to cover some of or substantially all of said at least part of the latch mechanism.

Substantially all of the latch mechanism may be provided on said outer surface.

The dirt separator may further comprise a lid movable between closed and open positions to selectively block and unblock an emptying aperture provided in the first dirt collection chamber, wherein the latch mechanism is arranged to selectively secure the lid in the closed position.

If the latch mechanism was not able to selectively secure the lid, and additional latch mechanism (which may have one or more of the drawbacks discussed above) may be needed.

The lid may further selectively block and unblock an emptying aperture provided in the second collection chamber. Preferably the lid is configured such that both said emptying apertures are blocked when the lid is in the closed position, and unblocked when the lid is in the open position.

The lid may be pivotably mounted to a wall of the first dirt collection chamber.

For the avoidance of doubt, the latch mechanism may, but need not necessarily, directly contact the lid.

The first and second dirt collection chambers may be movable relative to one another between first and second positions

This relative movement may be advantageous in that it can assist with shaking dirt off a component of the dirt separator, and/or the relative movement may be used to drive an additional operation within the dirt separator (such as the screen wiping operation discussed below).

The latch mechanism may be configured to selectively secure the first and second dirt collection chambers in the first position.

If the latch mechanism was not able to selectively secure the first and second dirt separators, and additional latch mechanism (which may have one or more of the drawbacks discussed above) may be needed.

Optionally, the first separation stage comprises air outlet which has an air-permeable screen; the separator further comprises a wiping member for clearing the screen; and the screen is movable with the first dirt collection chamber relative to the second collection chamber, and the wiping member is movable with the second dirt collection chamber relative to the first dirt collection chamber, such that moving the first and second dirt collection chambers relative to each other moves the wiping member across the screen.

Having a wiping member movable across the screen can clear the screen of dirt such as fluff and hair which may have wrapped around the screen or otherwise adhered thereto. Otherwise, build-up of dirt on the screen could clog it and thus affect performance of the separator.

The screen being wiped by movement of the first and second dirt collection chambers may avoid the need for a separate operation to be performed by a user. For instance, emptying the first and second dirt collection chambers may involve moving them to the second position. The screen would therefore be wiped automatically during emptying, rather than requiring a separate operation to be performed by the user.

The wiping member may be, for example, a brush or an elastomeric scraper.

The screen may extend circumferentially around a longitudinal axis defined by the separation stage.

The dirt separator may further comprise a biasing member arranged to urge the first and second dirt collection chambers towards the second position.

This may avoid the need for a user to apply the force necessary to move the dirt collection chambers to the second position. For example, where the latch mechanism is configured to secure the dirt collection chambers in the first position, the dirt separator may be arranged such that the user can move the dirt collection chambers to the second position simply by releasing the latch mechanism (whereupon the dirt collection chambers move to the second position under action of the biasing member).

The entire second separation stage may be movable relative to the first dirt collection chamber between said first and second positions.

This may avoid the need for the second dirt collection chamber to move relative to other parts of the second separation stage, which in turn may simplify the construction of the separator.

As an alternative, the second dirt collection chamber may be movable between the first and second positions relative to both the first dirt collection chamber and one or more other parts of the second dirt collection chamber. As another alternative, both the first and second dirt collection chambers may move relative to another part of the second separation stage.

A sidewall of the secondary dirt collection chamber may provide a guide feature which is configured to guide movement of the first dirt collection chamber relative to the second dirt collection chamber between the first and second positions.

The sidewall which provides the guide feature may or may not be the same sidewall as the one an outer surface of which at least part of the latch mechanism is provided on. The guide feature may be provided on said outer surface.

The first dirt collection chamber may define a storage volume for accommodating dirt separated by the first separation stage, and the second dirt collection chamber may be positioned outside of said storage volume.

This may separate said at least part of the latch mechanism from dirt contained in the first dirt collection chamber. In contrast, if the second dirt collection chamber were positioned inside the storage volume then dirt collected therein may work its way into the latch mechanism and clog it.

Instead or as well, this may maximise the storage capacity of the first dirt collection chamber.

Where the second dirt collection chamber is positioned outside said storage volume, it may nonetheless be partially or fully enclosed by the first dirt collection chamber.

The latch mechanism may comprise a latch member which is pivotable about a pivot axis so as to release the latch mechanism.

Use of a pivotable latch member may provide a latch mechanism which requires an advantageously low force to release it, and/or a latch mechanism which is beneficially long-lasting (for instance in comparison to a latch mechanism which utilised a latch member which bends, where the latch member may fatigue and snap).

The pivot axis may be substantially normal to said outer surface.

The latch member may be pivotally mounted on said outer surface.

The latch member may be a relatively bulky component of the latch mechanism, therefore this component being mounted on the sidewall may reduce the impact of the latch mechanism on the size and position of other components to a particularly advantageous extent.

The latch member being pivotable may make it particularly vulnerable to clogging from dirt, therefore this component being mounted on said outer surface (and thus being separated from the dirt in the second dirt collection chamber by said sidewall) may be particularly beneficial.

The dirt separator may have an axle projecting from said outer surface along the pivot axis and being rotatably received in an aperture in the latch member. As one alternative, the latch member may have an axle projecting along the pivot axis and being rotatably received in said outer surface.

The latch member may have a latch face, and a receiving surface received to receive an input force for pivoting the latch member and thereby releasing the latch mechanism, the distance between the receiving surface and the pivot axis being larger than the distance between the latch face and the pivot axis.

This may allow the latch mechanism to provide a ‘mechanical advantage’—if a given force is required to move the latch face so as to release the latch mechanism, a user would only need to apply a smaller force to the receiving surface due to the leverage provided by the latch member.

The distance between the receiving surface and the pivot axis may be at least 1.2 times the distance between the latch face and the pivot axis. For instance, the distance between the receiving surface and the pivot axis may be at least 1.4 times the distance between the latch face and the pivot axis.

The latch mechanism may comprise an actuation rod which defines a longitudinal axis, the actuation rod being reciprocably movable along its longitudinal axis relative to said sidewall, and being configured to pivot the latch member so as to release the latch mechanism.

The actuation rod may allow linear movement of a component (for instance the pressing of a button to be used to pivot the latch member so as to release the latch mechanism. This may be a particularly intuitive mechanism for a user, and/or may allow the latch mechanism to be advantageously compact.

The actuation rod may be push rod which is configured to transmit axial compression so as to pivot the latch member. Alternatively, the actuation rod may be a pull-rod which is configured to transmit axial tension so as to pivot the latch member.

The actuation rod may be reciprocably mounted on said outer surface.

The actuation rod and the means for supporting it reciprocably may be a relatively bulky component of the latch mechanism, therefore this part being mounted on the sidewall may reduce its impact on the size and position of other components to a particularly advantageous extent.

The actuation rod being reciprocable may make it particularly vulnerable to clogging from dirt, therefore this component being mounted on said outer surface (and thus being separated from the dirt in the second dirt collection chamber by said sidewall) may be particularly beneficial.

Optionally, the dirt separator has an attachment mechanism for releasably attaching the dirt separator to a vacuum cleaner; the attachment mechanism has an operating member which is configured to be manipulated by a user so as to release the attachment mechanism; and the latch mechanism is linked to the operating member such that manipulation of the operating member can release the latch mechanism.

This may improve the speed and simplicity with which different operations can be performed. For instance where the latch mechanism secures the lid, the separator may be arranged such that if a user wishes to empty the dirt separator while it is attached to a vacuum cleaner, they can simply manipulate the operating member for a first time to detach the dirt separator from the vacuum cleaner and then manipulate the operating member for a second time to release the lid to empty the first dirt collection chamber.

Instead or as well, the latch mechanism being linked to the operating member may eliminate the need for a separate operating member (which may be a relatively bulky component) to be provided for the latch mechanism. This can reduce the overall size of the machine, and/or reduce the number of component parts of the separator and thus reduce its production cost.

Preferably, the attachment mechanism and the latch mechanism are configured such that manipulation of the operating member when the dirt separator is attached to a vacuum cleaner releases the attachment mechanism, and such that manipulation of the operating member when the dirt separator is separate from a vacuum cleaner releases the latch mechanism. This can avoid the risk of the latch member being inadvertently released when the operating member is manipulated with the intention of detaching the dirt separator from the vacuum cleaner.

The first separation stage may be a cyclonic separation stage.

Optionally, the first separation stage comprises a cyclone chamber positioned inside the first dirt collection chamber; and the cyclone chamber defines a longitudinal axis, and defines a circumferentially-extending slot which forms a dirt outlet through which dirt in the cyclone chamber can enter the first dirt collection chamber.

The second separation stage may be a cyclonic separation stage.

The second separation stage preferably comprises two or more cyclone chambers arranged in parallel.

Optional or preferred features of different aspects of the invention, or of arrangements useful for understanding the invention, may also apply to (other) aspects of the invention or arrangements useful for understanding the invention, as appropriate.

### BRIEF DESCRIPTION OF THE DRAWINGS

Embodiments of the present invention will now be described, by way of example only, with reference to the accompanying drawings in which:

FIG. 1 is a perspective view of a vacuum cleaner according to an embodiment of the invention;

FIG. 2 is a front perspective view of a dirt separator of the vacuum cleaner of FIG. 1, with dirt collection chambers in a first position;

FIG. 3 is a rear perspective view of the dirt separator of FIG. 2;

FIG. 4 is a side cross-sectional view of the dirt separator of FIGS. 2 and 3;

FIG. 5 is a cutaway perspective view of the dirt separator of FIGS. 2-4;

FIG. 6 is a rear perspective view of the dirt separator with the dirt collection chambers in a second position;

FIG. 7 is a further rear perspective view of the dirt separator with the dirt collection chambers in the second position;

FIG. 8 is a cutaway perspective view of the dirt separator with the dirt collection chambers in the second position;

FIG. 9 is a rear perspective view of a housing of a first separation stage of the dirt separator;

FIG. 10 is a rear perspective view of the dirt separator with a shield over a latch mechanism removed;

FIG. 11 is an enlargement of part of FIG. 10;

FIG. 12 is a rear perspective view of the dirt separator with first and second assemblies separated from one another;

FIG. 13 is a side perspective view of the dirt separator with first and second assemblies separated from one another;

FIG. 14 is a simplified axial cross-section through the dirt separator, taken normal to a longitudinal axis of a first separation stage; and

FIG. 15 is a perspective view from underneath of a second assembly of the dirt separator.

### DETAILED DESCRIPTION OF THE INVENTION

Throughout the description and drawings, corresponding reference numerals denote corresponding features.

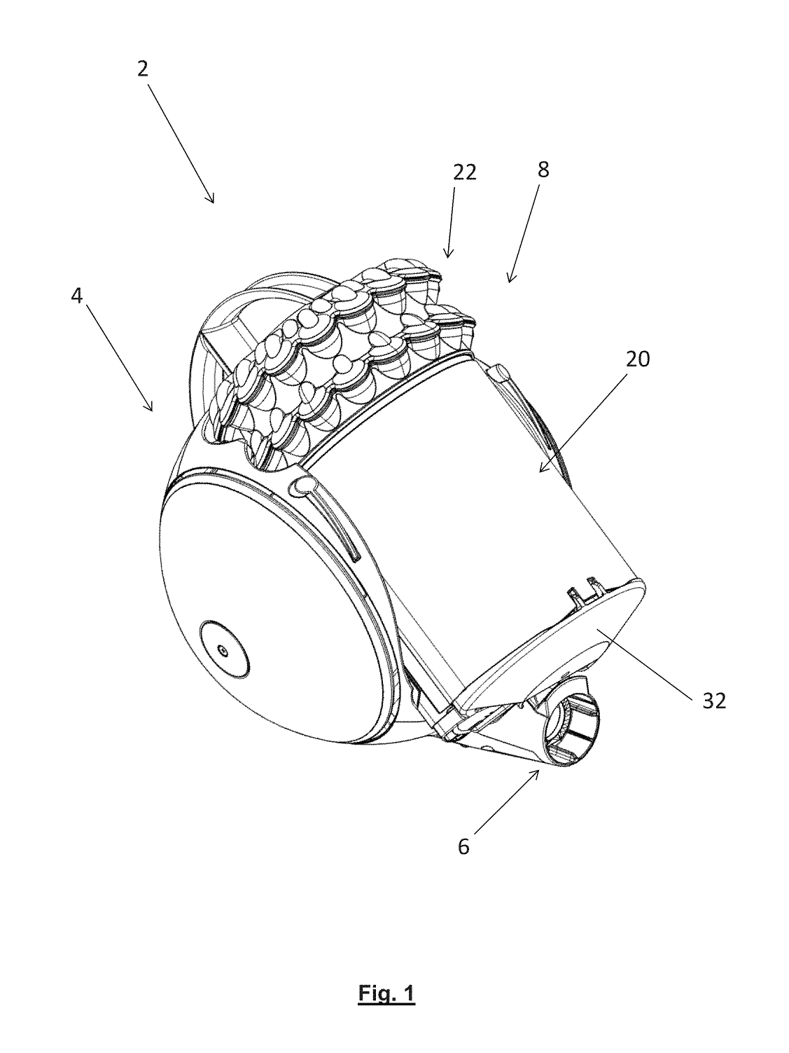

FIG. 1 shows a vacuum cleaner 2 according to an embodiment of the invention. The vacuum cleaner 2 of this embodiment is a cylinder vacuum cleaner. It has a rolling assembly 4 which has an inlet 6 for connection to a suction nozzle (not shown) via a wand and hose (not shown), and a dirt separator 8. In use, a user grasps the wand and moves the suction nozzle over a surface to be cleaned, pulling the vacuum cleaner 2 behind them when necessary by pulling on the hose. Dirt laden air is drawn into the suction nozzle (not shown) by a suction generator in the form of a motor-driven fan (not visible) housed inside the rolling assembly 4. The air is sucked through the wand and hose and enters the inlet 6 of the vacuum cleaner, whereupon the air is ducted to the dirt separator 8. The dirt separator 8 separates dirt from the air as discussed in more detail below. The clean air then passes into the suction generator and is exhausted from the vacuum cleaner 2.

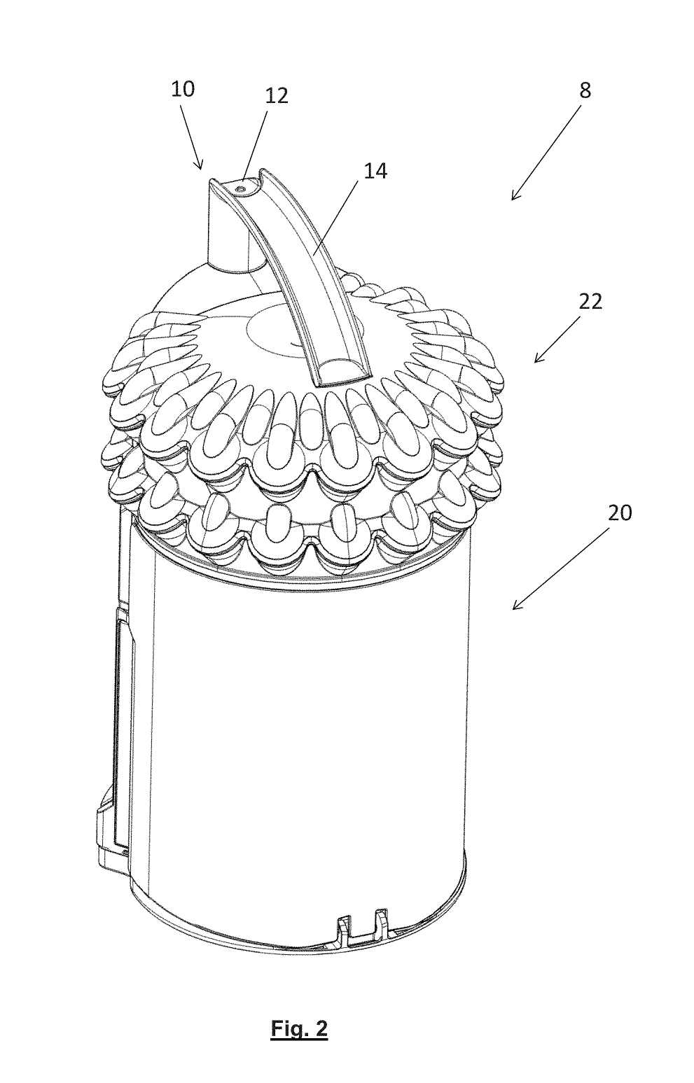

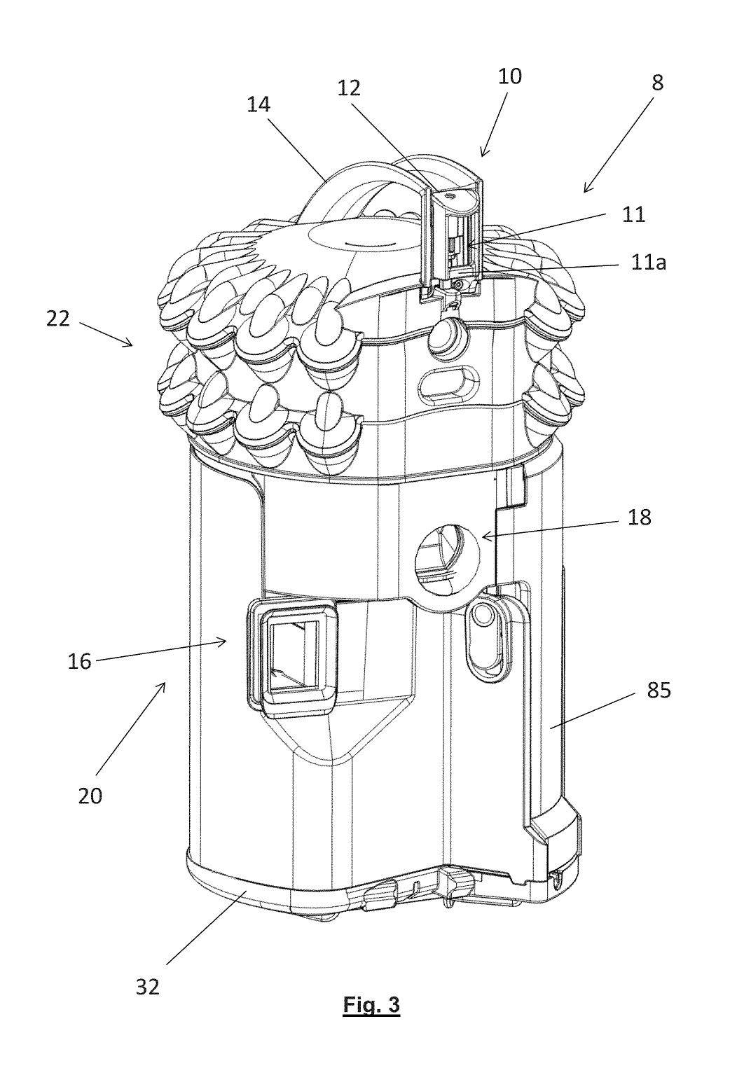

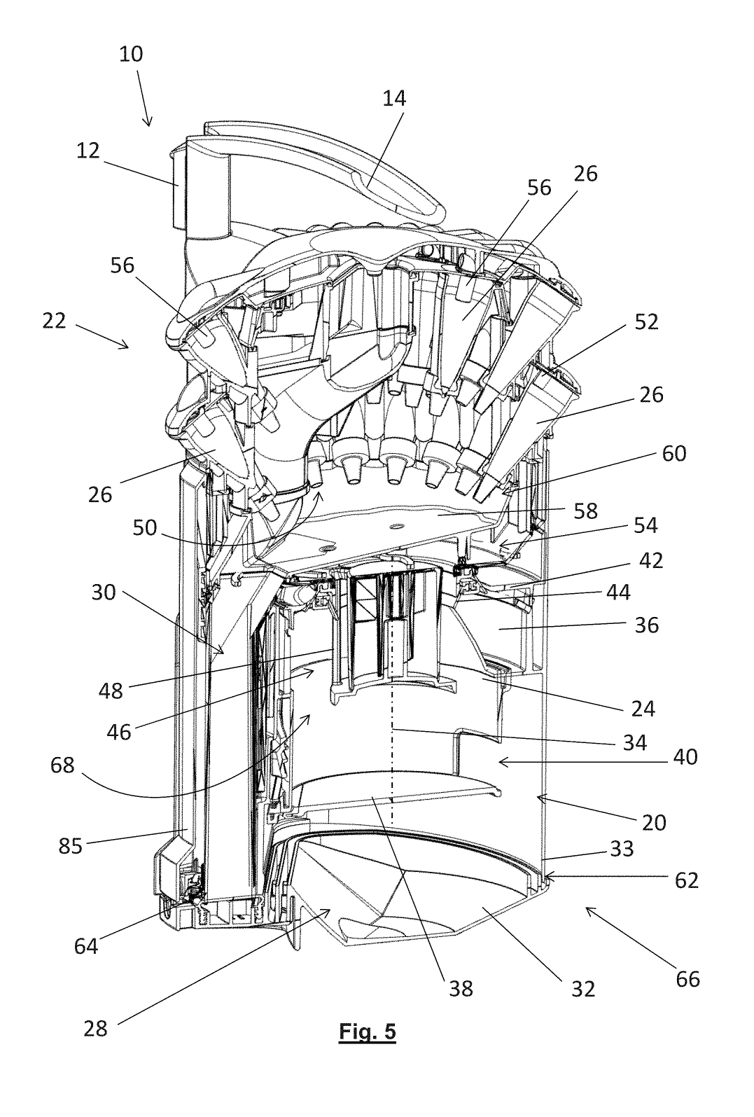

The dirt separator 8 of the vacuum cleaner 2 is shown in isolation in FIGS. 2-5. Referring to these figures in combination with FIG. 1, the dirt separator 8 is releasably attachable to the rolling assembly 4 of the vacuum cleaner 2 by an attachment mechanism 10. A hook-shaped projection (not visible) projects from the rolling assembly 4, and is received in an aperture 11 in an operating member 12 provided on the dirt separator 8. The projection (not visible) is positioned to hook onto a lower edge 11a of the aperture 11 so as to prevent the dirt separator 8 from being pulled away from the vacuum cleaner 2.

The operating member 12 is reciprocably mounted on a handle 14 of the dirt separator, and is biased upwards. To release the attachment mechanism 10, the user manipulates the operating member by pressing it downwards relative to the handle 14 (and relative to the remainder of the dirt separator 8 and vacuum cleaner 2). This moves the lower edge 11a of the aperture 11 downwards, out of engagement with the hooked projection (not visible), so that the dirt separator 8 can be detached from the vacuum cleaner 2.

The dirt separator 8 has a separator inlet 16, a separator outlet 18, a first separation stage 20, and a second separation stage 22 downstream of the first separation stage. The first separation stage 20 is a cyclonic separation stage, which in this particular embodiment is the primary separation stage of the separator 8 (i.e. it is the separation stage furthest upstream within the dirt separator 8). The first separation stage 20 of this embodiment comprises a single cyclone chamber 24. The second separation stage 22 of this embodiment is directly downstream of the first separation stage 20, and has a plurality of cyclone chambers 26 arranged in parallel.

The first separation stage 20 has a first dirt collection chamber 28, and the second separation stage 22 has a second dirt collection chamber 30. Each dirt collection chamber is configured to store dirt removed by the associated cyclone chamber(s). The first dirt collection chamber 28 takes the form of a generally D-shaped bin. The second dirt collection chamber 30 is approximately cuboidal and is positioned outside of the first dirt collection chamber 28 as discussed in more detail later. The separator 8 has a lid 32 which is pivotably mounted to a wall 33 of the first dirt collection chamber 28. The lid 32 can close the first and second dirt collection chambers 28, 30 as described in more detail later.

The cyclone chamber 24 of the first separation stage 20 is generally cylindrical, defines a longitudinal axis 34 of the first separation stage, and is positioned inside the first dirt collection chamber 28. An inlet 36, in the form of a passageway spiralling radially inwards, is provided at an upper axial end of the cyclone chamber 22. An axial end wall 38 and a circumferentially-extending slot 40 are provided at the opposite axial end of the cyclone chamber 24. An upper wall 42 of the inlet 36 supports a wiping member 44 in the form of a frusto-conical elastomeric scraper. The first separation stage has an air outlet 46 in the form of a ‘shroud’, which includes an air permeable screen (not shown) supported on support beams 48. The screen (not shown) extends circumferentially around the longitudinal axis 34, in this case the entire 360 degrees around the axis.

Each cyclone chamber 26 of the second separation stage 22 is generally frusto-conical, with an open tip 50. Each cyclone chamber 26 has an inlet 52 in communication with a plenum chamber 54, and an outlet 56 in the form of a ‘vortex finder’. The second stage also has an angled plate 58 in an intermediate chamber 60 positioned generally above the second dirt collection chamber 30.

In use, dirty air sucked into the inlet 6 of the vacuum cleaner 2 is ducted to the separator inlet 16, and then runs through the inlet 36 of the first separation stage and into the cyclone chamber 24. The air then forms a cyclone inside the cyclone chamber 24. Relatively coarse dirt is thrown outwards, whereupon it contacts the cyclone chamber 24. The cyclone chamber 24 slows the dirt through friction. The dirt falls into the first dirt collection chamber 28 through the slot 40, which acts as a dirt outlet of the first separation stage 20. The remaining air, along with relatively fine dirt still entrained therein, is sucked out of the cyclone chamber 24 through the air outlet 46 (and through the screen), into the plenum chamber 54. The airflow is then split into multiple sub-flows, each of which enters one of the cyclone chambers 26 of the second separation stage 22 through its associated inlet 52. Each sub-flow then forms a cyclone within its respective cyclone chamber 26. The fine dirt in each sub-flow is thrown outwards, drops down out of the cyclone chamber 26 through the open tip 50 and into the intermediate chamber, whereupon the angled plate 58 directs it into the second dirt collection chamber 30. The sub-flows are drawn out of the cyclone chambers 26 through their associated vortex finders 56, whereupon they are re-combined into a single flow and exit the dirt separator 8 through the outlet 18.

The lid 32 is shown in a closed position in FIGS. 1-5. In this position, it blocks emptying apertures 62, 64 in the first and second dirt collectors 28, 30 respectively. To empty the collected dirt out of the separator 8, the lid 32 is moved to the open position so as to unblock the emptying apertures 62, 64 and allow dirt to exit the dirt collection chambers 28, 30 therethrough.

In this embodiment, the emptying process is assisted by the first and second dirt collection chambers 28, 30 being movable relative to one another between first and second positions. More particularly, in this embodiment the entire second separation stage 22 is movable relative to the first dirt collection chamber 28—a first assembly 66 (which includes the first dirt collection chamber 28, cyclone chamber 24, inlet 36, wiping member 44 and axial wall 38) is movable relative to a second assembly 68 (which includes the second separation stage 22 and the outlet 46 of the first separation stage). FIGS. 1-5 show the first and second assemblies 66, 68 (and therefore the first and second dirt collection chambers 28, 30) in the first position, in which the separator is configured for normal use.

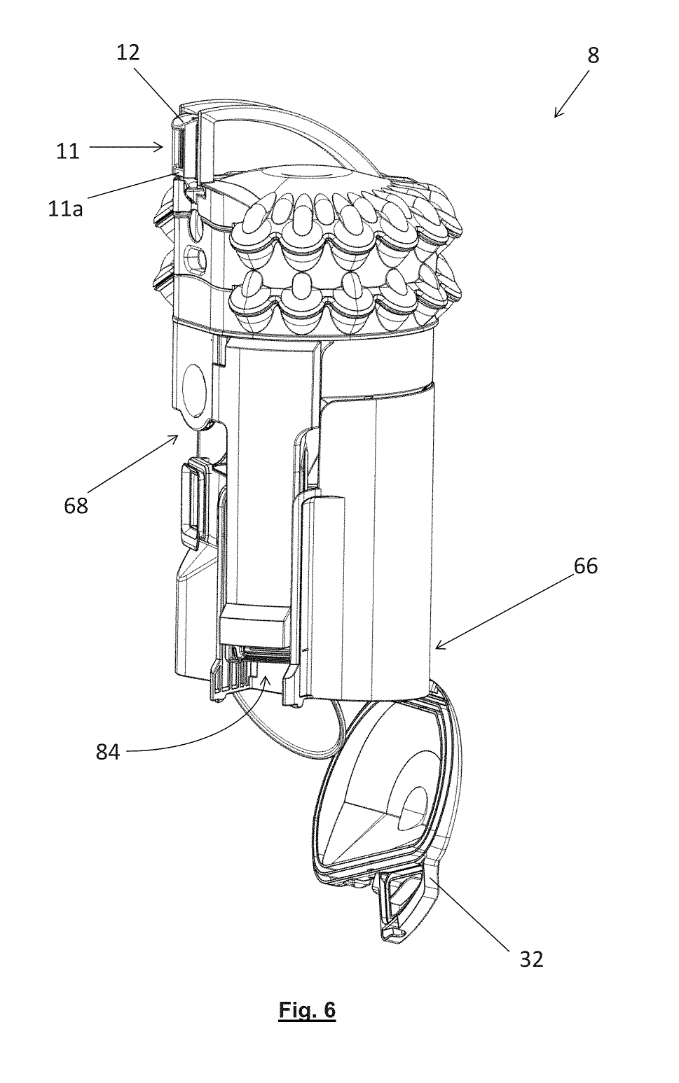

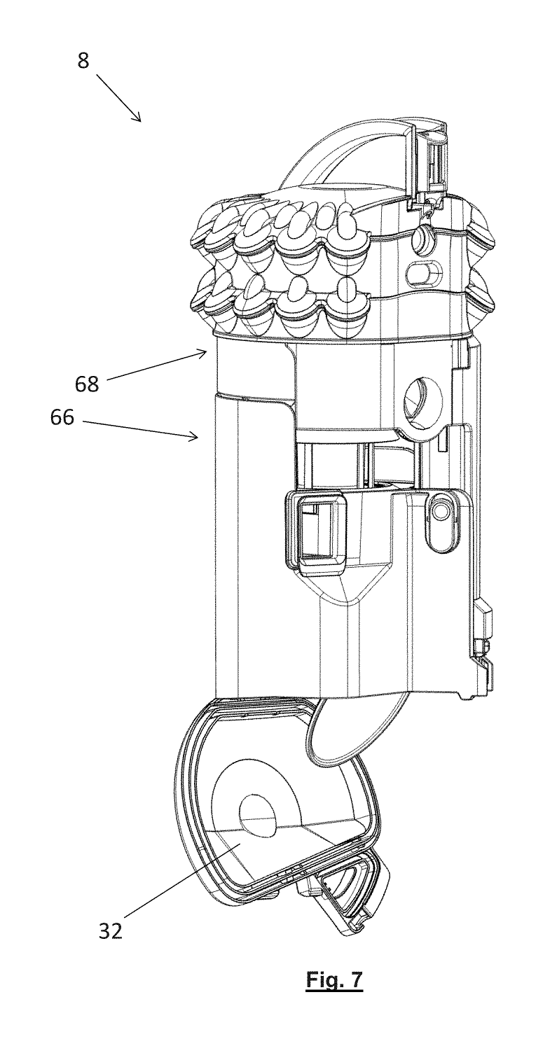

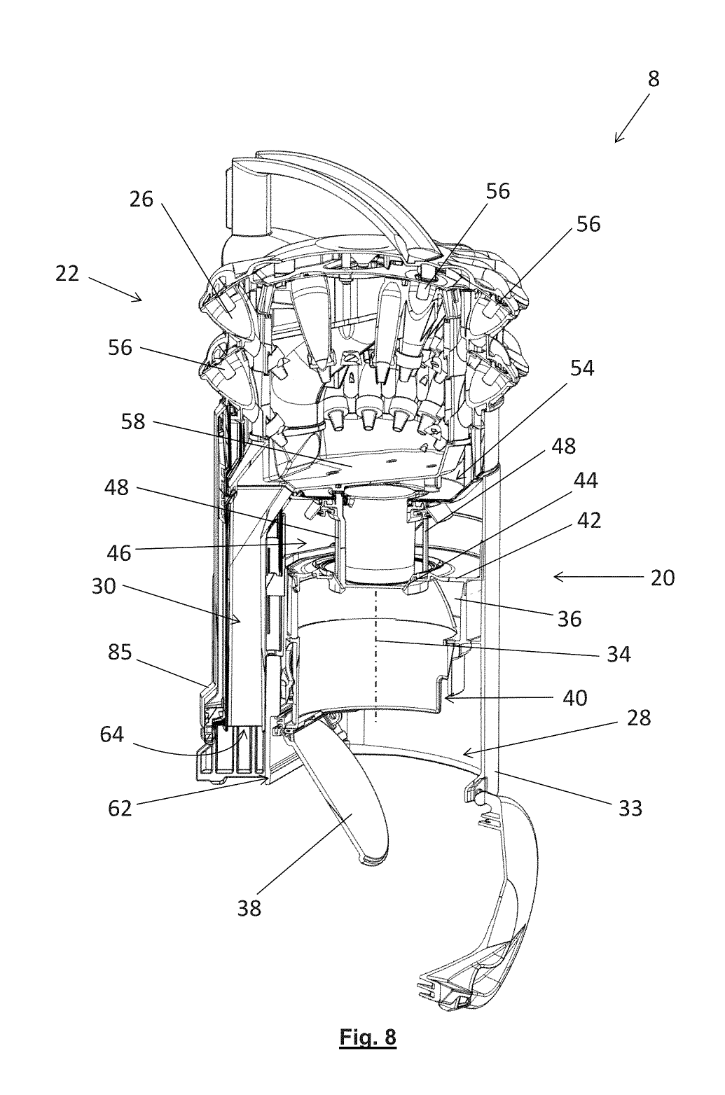

FIGS. 6-8 show the dirt separator 8 with the lid 32 in the open position, and with the first and second dirt collection chambers 28, 30 (and the assemblies 66, 68 associated therewith) in the second position. In this configuration, the dirt separator 8 is configured for emptying the dirt collection chambers 28, 30. With the lid 32 in the open position, the emptying apertures 62, 64 are unblocked and the dirt contained in the dirt collection chambers 28, 30 can drop into a bin.

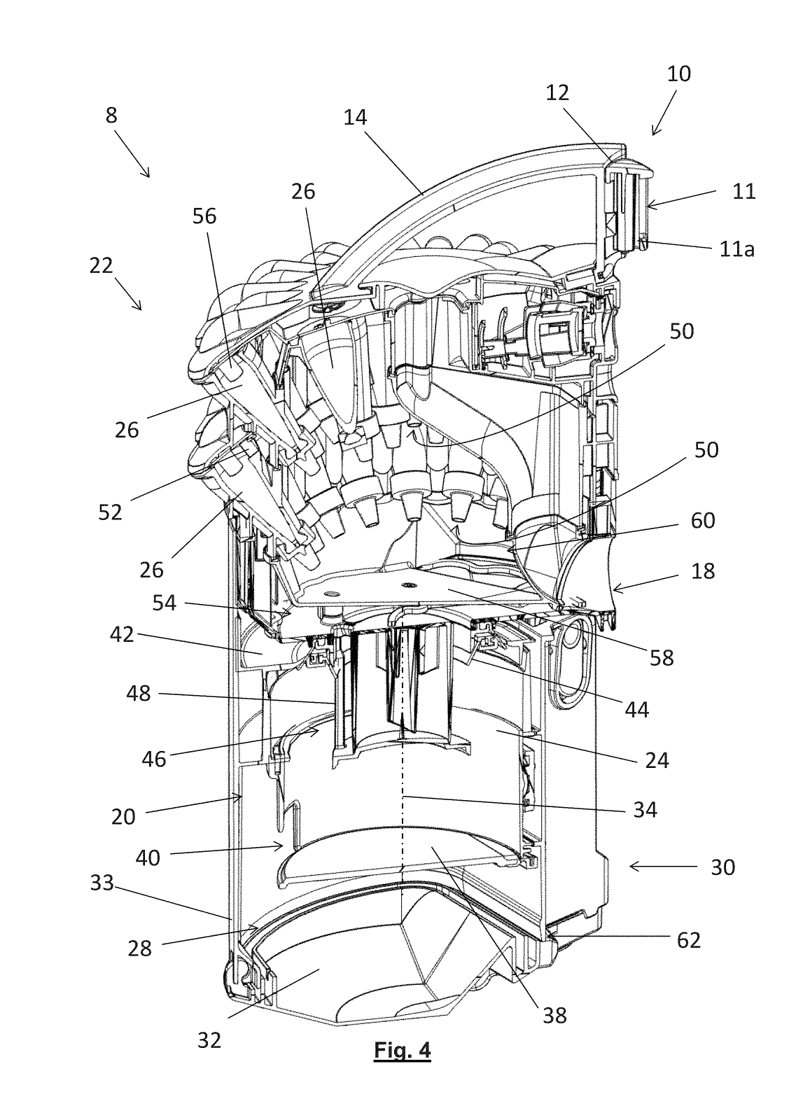

Movement of the dirt collection chambers 28, 30 from the first position to the second position performs a ‘shroud wiping’ operation. Since the first assembly 66, which includes the screen (not visible), is movable relative to the second assembly 68, which includes the wiping member 44, moving the first and second dirt collection chambers 28, 30 (i.e. the first and second assemblies) relative to one another moves the wiping member 44 and screen relative to one another. More particularly, when the dirt collection chambers 28, 30 are moved from the first position to the second position, the wiping member 44 moves over the screen so as to scrape off the screen any dirt that has adhered thereto. Dirt scraped off the screen can then fall out of the cyclone chamber, into the first dirt collection chamber 28 and out through the emptying aperture 62. Movement of the wiping member 44 across the screen is shown most clearly by comparing FIGS. 4 and 5 to FIG. 7.

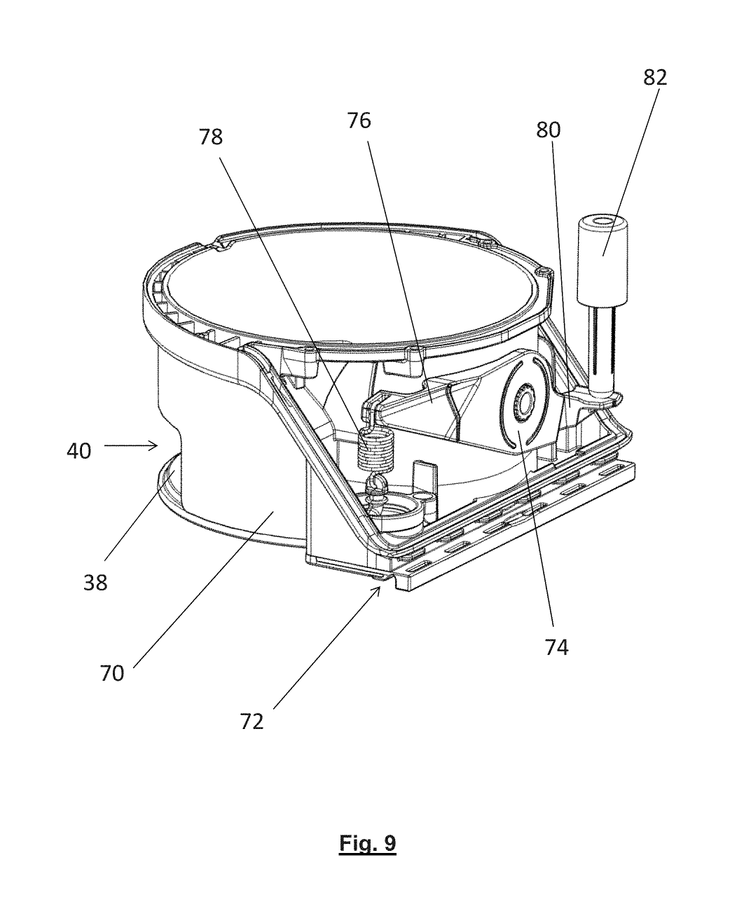

FIGS. 6-8 show that when the lid 32 is opened and the first and second dirt collection chambers 28, 30 are moved to the second position, the axial end wall 38 pivots downwards relative to the cyclone chamber 24 of the first dirt collection chamber. This helps to ensure that dirt scraped off the screen by the wiping member 44 falls into the first dirt collection chamber 28, rather than coming to rest on top of the axial end wall 38 (whereupon it could re-adhere to the screen when the vacuum cleaner 2 was next used). When the lid 32 is closed and the dirt collection chambers 28, 30 returned to the first position, the axial end wall 38 returns to the position shown in FIGS. 1-5. The mechanism by which the axial end wall 38 is pivoted is not material to the present invention, but will be discussed briefly below with reference to FIG. 9 for the sake of completeness.

An axially lower portion of the cyclone chamber 24 is defined by a housing 70 which includes the slot 40, and to which the lower axial wall 38 is pivotably attached by an elastomeric membrane hinge 72. Pivotably mounted on the opposite side of the housing 70 to the slot 40 is a see-saw 74 one end 76 of which is attached to the end wall 38 by a tensile spring 78 and the other end 80 of which is positioned in the path of a reciprocable piston 82.

FIG. 9 shows the see-saw 74 in the position it occupies when the first and second assemblies 66, 68 are in the first position. In this position, the piston 82 is held down by a projection (not visible) of the second assembly 68. The piston 78 holds the associated end 80 of the see-saw 74 down, which holds the other end 76 of the see-saw up. This applies tension to the spring 78, which in turn pulls upwards on the end wall 30 so that it remains in contact with the housing.

When the first and second assemblies are in the second position, the piston 82 is no longer held down by the projection (not visible) of the second assembly 68. The see-saw 74 is therefore free to pivot relative to the housing 70. The end wall 38 can therefore pivot down under its own weight to the position shown in FIGS. 6-8, pulling on the spring 78 and pulling the associated end 76 of the see-saw 74 downwards.

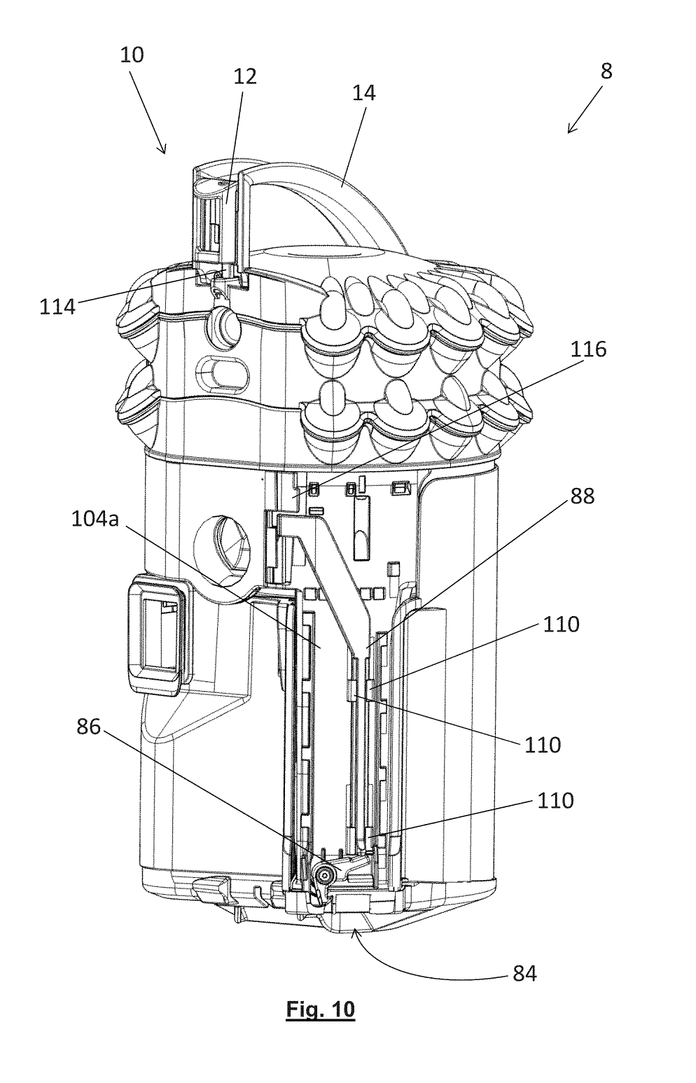

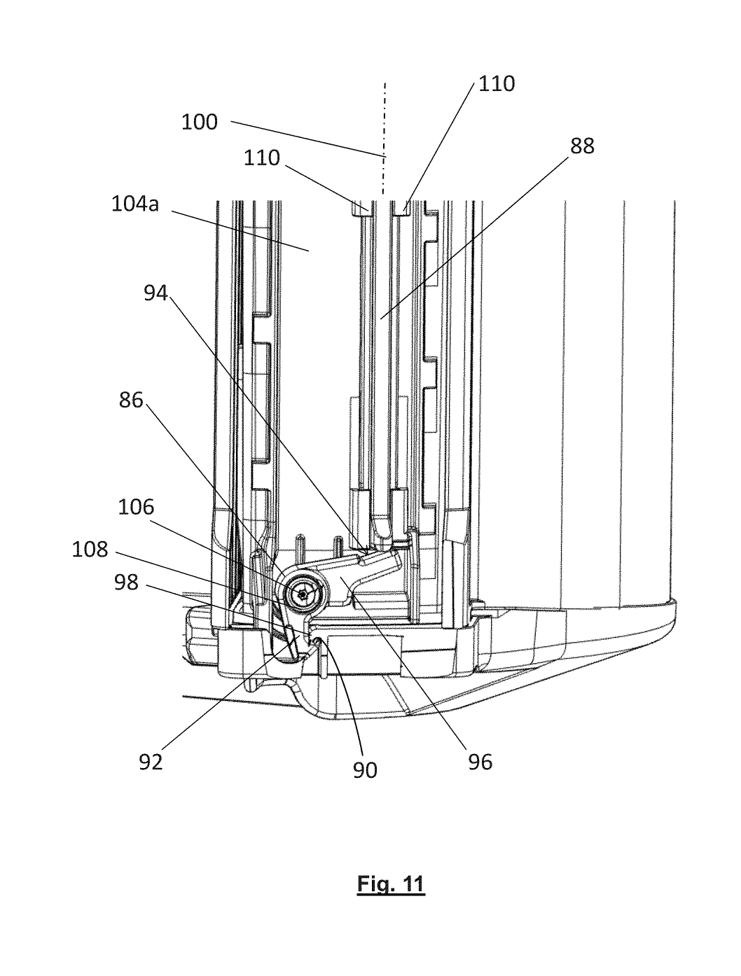

The position of the lid, and the relative positions of the dirt collection chambers, is controlled by a latch mechanism 84. The latch mechanism 84 is selectively releasable, having securing and releasing configurations. Substantially all of the latch mechanism 84 is covered by a shield 85 which in this case forms part of the outer periphery of the dirt separation chamber, and protects the latch mechanism 84 from knocks. The latch mechanism is shown more clearly in FIGS. 10 and 11, in which the shield 85 has been removed. These figures show the latch mechanism 84 in the securing configuration.

In this embodiment, the latch mechanism 84 both secures the dirt collection chambers 28, 30 in the first position and secures the lid 32 in the closed position when the latch mechanism is in the securing configuration, and allows the dirt collection chambers 28, 30 to move towards the second position and the lid 32 to move towards the open position when the latch mechanism 84 is in the releasing configuration.

In this case, the latch mechanism 84 selectively engages the lid 32. More particularly, when the latch mechanism 84 is in the securing position it clasps the lid 32 against the second dirt collection chamber 30 (and against the first dirt collection chamber 28) and holds it closed. Since the lid 32 is attached to the first dirt collection chamber 28, by holding the lid against the second dirt collection chamber 30 the latch mechanism 84 also holds the first dirt collection chamber 28 relative to the second dirt collection chamber 30 (i.e. holds the dirt collection chambers in the first position. When the latch mechanism 84 is in the releasing position it no longer clasps the lid 32 against the second dirt collection chamber 30. The lid is 32 therefore free to move to the open position, and similarly the first dirt collection chamber 28 is free to move relative to the second dirt collection chamber 30 so that the dirt collection chambers move towards the second position.

In this embodiment the latch mechanism 84 has a pivotable latch member 86, and a reciprocable actuation rod 88 which is configured to pivot the latch member 86 so as to release the latch mechanism (i.e. move the latch mechanism to the releasing configuration). The latch member 86 has a latch face 90 provided on a first arm 92, and a receiving surface 94 provided on a second arm 96. The latch face 90 hooks onto a ledge 98 provided on the lid 32 so as to clasp the lid against the second dirt collection chamber 30 when the latch mechanism 84 is in the securing position, and is moved out of alignment with the ledge so as to allow the lid to move when the latch mechanism is in the releasing position. The receiving surface 94 is positioned to receive an input force for pivoting the latch member 86 so as to release the latch mechanism 84. In this case the input force is exerted on the latch member 86 by the actuation rod 88.

The actuation rod 88 defines a longitudinal axis 100, and is movable along the longitudinal axis relative to the sidewall of the second dirt collection chamber 30 to which it is mounted (as discussed below). In this case, the actuation rod is a push rod and is configured to transmit axial compression—when the upper end of the actuation rod 88 is pressed downwards, the rod moves downwards and its lower end presses the receiving surface 94 of the latch member. This pushes the second arm 96 down, thereby pivoting the latch member 86 (clockwise from the perspective of FIGS. 10 and 11). The latch member 86 pivoting moves the first arm 92 away from the ledge 98 of the lid 32 (i.e. generally to the left from the perspective of FIGS. 10 and 11), which and unhooks the latch face 90 from the ledge and releases the lid. The lid 32 can then move towards the open position and the dirt collection chambers 28, 30 can move towards the second position.

In this case, the dirt separator 8 includes a biasing member (not visible) which urges the dirt collection chambers 28, 30 away from the first position and towards the second position. Accordingly, as soon as the latch face 90 is unhooked from the ledge 98, the first dirt collection chamber 28 begins to move relative to the second dirt collection chamber 30. In other embodiments, however, the user may manually move the dirt collection chambers 28, 30 towards the second position after releasing the latch mechanism 84.

In this embodiment, part of the latch mechanism 84 is provided on a sidewall of the second dirt collection chamber 28, more particularly an outer surface of that sidewall. In this embodiment, both the latch member 86 and the actuation rod 88 (i.e. both moving parts, which in this case collectively form substantially all of the latch mechanism) are so provided. The latch member 86 and the actuation rod 88 are both mounted on the same outer surface of a sidewall 104a of the second dirt collection chamber 30. The latch member 86 is rotatably mounted on an axle which projects from the outer surface and defines the pivot axis 106 for the latch member, and is held against the outer surface by a circlip 108. In this case the pivot axis 106 is substantially normal to the outer surface of the sidewall 104a. A set of retaining tabs 110 projecting from the outer surface overlie the actuation rod 88, holding it against the outer surface while allowing it to slide along its longitudinal axis 100.

The baising member (not visible) urging the dirt collection chambers 28, 30 towards the second position means that a relatively high force is transmitted from the ledge 98 of the lid 32 to the latch face 90 of the latch member 86. As a result, relatively high frictional forces oppose movement of the latch face 90 out of engagement with the ledge 98. In this embodiment this effect is counteracted by the latch member providing a mechanical advantage—the distance between the receiving surface 94 and the pivot axis 106 is larger than the distance between the latch face 90 and the pivot axis 106. Due to the leverage provided by the latch member 86, for a given force needed to overcome the friction between the ledge 98 and latch face 90 so as to move the first arm 92, a smaller force can be applied to the receiving surface 94 by the actuation rod 88. In this case the distance between the receiving surface 94 and the pivot axis 106 is around 1.5 times larger than the distance between the latch face 90 and the pivot axis 106, therefore the force which must be exerted on the receiving surface 94 to pivot the latch member 96 is around two thirds of the force needed to overcome the friction between the latch face 90 and the ledge 98.

The latch mechanism 84 is linked to the operating member 12 of the release mechanism 10 such that manipulation of the operating member can release the latch mechanism 84. A linkage member 114 (largely hidden beneath the surface of the dirt separator 8) extends between the operating member 12 and the actuation rod 88, and is reciprocably movable along the longitudinal axis 100 of the actuation rod. The linkage member 114 is configured such that when a user manipulates the operating member 12 by depressing it, the operating member pushes the linkage member 114 downwards. A lower end 116 of the linkage member 114, in turn, pushes the actuation rod 88 downwards, and this releases the latch mechanism 84 by pivoting the latch member 86 as described above.

In this embodiment, the attachment mechanism 10 and latch mechanism 84 are configured such that manipulation of the operating member 12 when the dirt separator 8 is attached to the vacuum cleaner 2 releases the attachment mechanism, and such that manipulation of the operating member when the dirt separator is separate from the vacuum cleaner releases the latch mechanism. This is achieved by the lower end 116 of the linkage member being movable inwards so that it moves out of alignment with the actuation rod 88. When the dirt separator 8 is separate from the vacuum cleaner 2, the lower end 116 of the linkage member 114 is aligned with the actuation rod 88 and depression of the operating member 12 releases the latch mechanism 84 as described above. When the dirt separator 8 is attached to the vacuum cleaner 2, a projection (not visible) on the rolling assembly 4 pushes the lower end 116 inwards and out of alignment with the actuation rod 88. In this position depression of the operating member 12 still moves the linkage member 114, but the linkage member does not move the actuation rod 88 and therefore the latch mechanism 84 remains in the securing configuration.

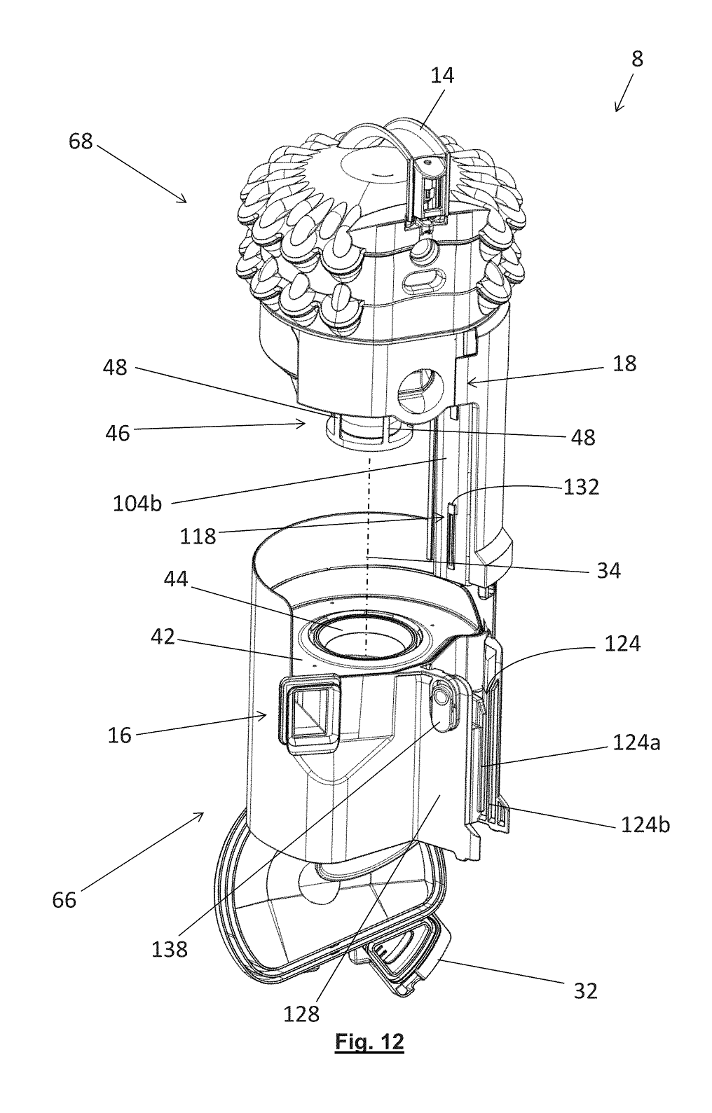

According to the present invention, a guide feature is provided on a sidewall of the second dirt collection chamber. In this case, two guide features are each provided on an outer surface of a sidewall of the second dirt collection chamber. This is shown more clearly in FIGS. 12-14. In this case a first guide feature 118 is provided on an outer surface of one sidewall 104b, and a second guide feature 120 is provided on an outer surface of a different sidewall 104d. The guide features 118, 120 are configured to guide movement of the dirt collection chambers 28, 30 between the first and second positions. They provide lateral and rotational support, allowing the dirt collection chambers 28, 30 to move between positions with increased stability. This can not only reduce wear, but also make the dirt separator 8 feel sturdier and thus of higher quality in the hands of a user.

It will be appreciated that if the guide features 118, 120 were positioned close together, the guiding support offered thereby would be more localised. Accordingly, greater stability can be afforded to the guiding action of the guide features 118, 120 if they are positioned further apart from one another. The guide features 118, 120 being provided on different sidewalls 104b, 104d can assist in accomplishing this. Further, in this embodiment the guide features 118, 120 are positioned on opposite sides of the second dirt collection chamber 30 (and in this case are positioned generally opposite to one another in a circumferential direction around the longitudinal axis 34 of the cyclone chamber 24 of the first separation stage 20). This further increases the spacing between the guide features 118, 120 and thus the stability of the guiding support offered thereby.

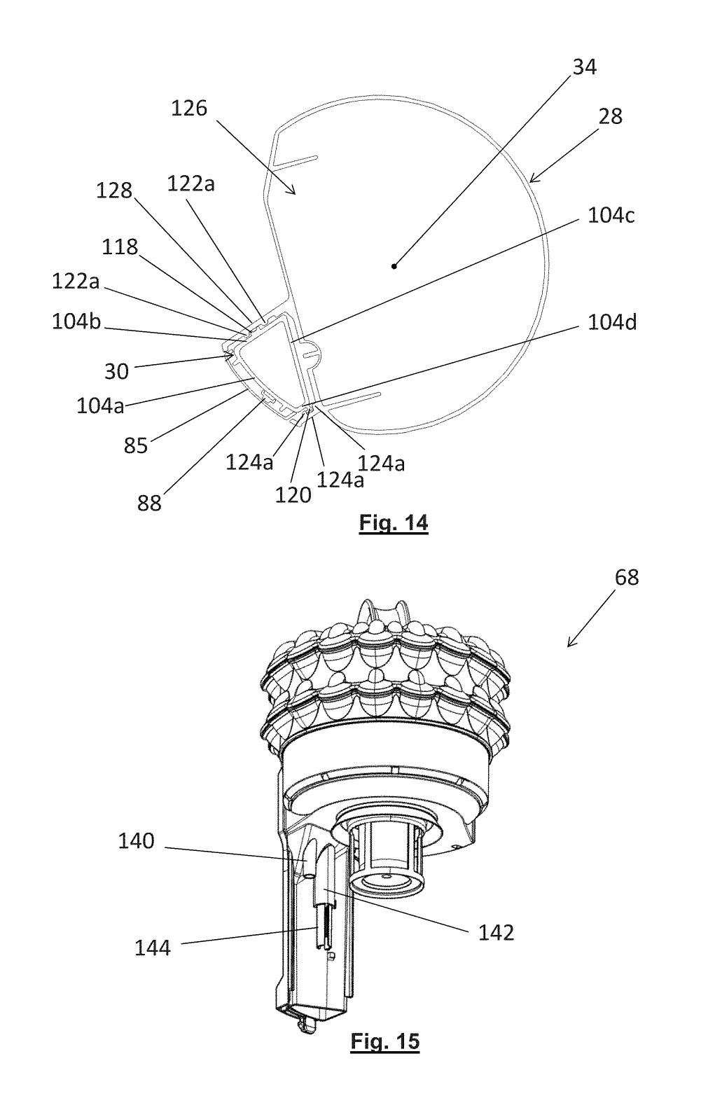

Each guide feature 118, 120 contacts the first dirt collection chamber 28. More particularly, the guide features 118, 120 each engage with a complementary feature provided on the first dirt collection chamber 28. The first guide feature 118 takes the form of a runner which engages a first complementary feature 122 in the form of a track defined between two ridges 122a, 122b. The second guide feature 120 takes the form of rail that engages a second complementary feature 124 which is also in the form of a track defined between two ridges 124a, 124b. This is shown most clearly in FIG. 14. The guide features 118, 120 and complementary features 122, 124 co-operate to guide the movement of the first and second dirt collection chambers 28, 30 between the first and second positions.

FIG. 14 also shows the relative positions of the primary and secondary dirt collection chambers 28, 30 more clearly. The first dirt collection chamber 28 defines a storage volume 126 for accommodating dirt separated by the first separation stage 20, and the second dirt collection chamber 28 is positioned outside of the storage volume. Accordingly, components such as the latch member 86 and the actuation rod 88 of the latch mechanism 84 and the guide features 118, 120 are not exposed to dirt contained in the storage volume 126. The second dirt collection chamber 30 is, however, partially enclosed by the first dirt collection chamber 28—the first dirt collection chamber 28 has a pair of auxiliary walls 128, 130 between which the second dirt collection chamber 30 is received. The second dirt collection chamber 30 is not fully enclosed by the first dirt collection chamber 28, however. The sidewall 104a upon which the latch member 86 and actuation rod 88 are mounted is left exposed.

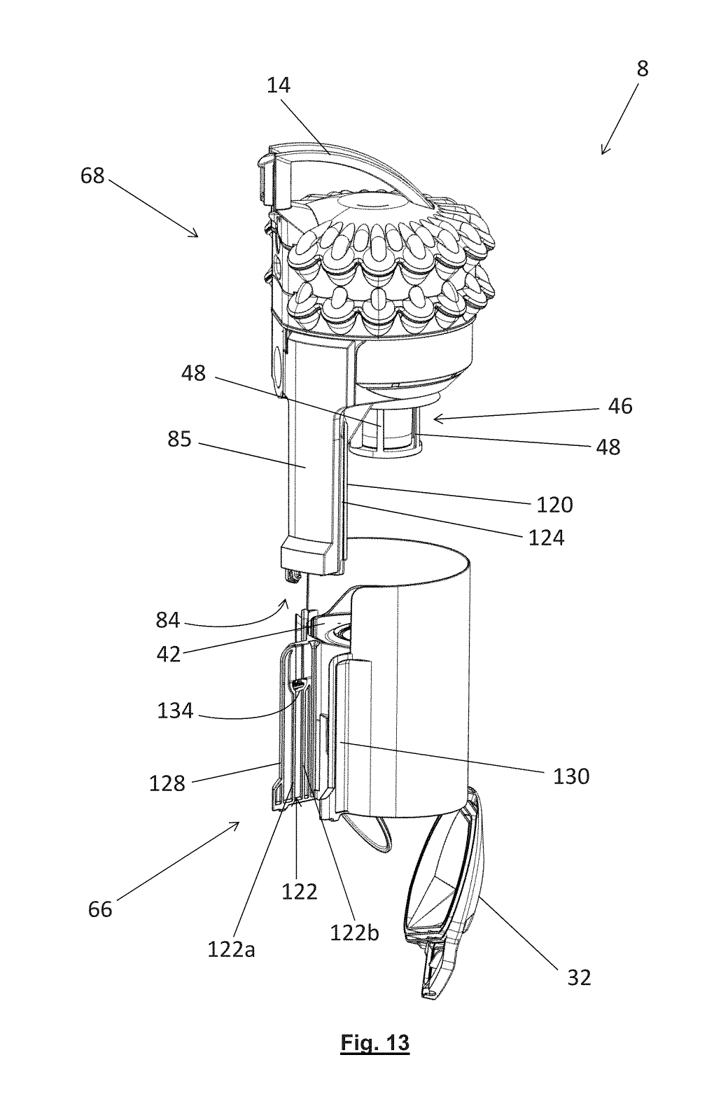

As shown in FIGS. 12 and 13, the first and second assemblies 66, 68 (and thus the first and second dirt collection chambers 28, 30) can be separated from one another. This is achieved by moving the first and second assemblies 66, 68 beyond the second position from the first position (i.e. by moving them from the first position to the second position, and then continuing to move them in the same direction).

The dirt separator 8 of this embodiment comprises a pair of stop surfaces 132, 134 which abut when the first and second assemblies 66, 68 (and thus the first and second dirt collection chambers 28, 30) are in the second position, thereby preventing them moving from the first position beyond the second position. Accordingly, in this embodiment the stop surfaces 132, 134 can stop the dirt collection chambers 28, 30 being separated from one another inadvertently. One of the stop surfaces 132 is provided at an end of the runner 118. That 132 stop surface is therefore provided on a sidewall of the dirt collection chamber (more particularly the outer surface of sidewall 104b). The other stop surface 134 is provided at a corresponding end of the associated track 122. With the first and second dirt collection chambers 28, 30 are in the first position, the stop surfaces 132, 134 are spaced apart. As the dirt collection chambers 28, 30 move towards the second position the stop surfaces 132, 134 approach one another, and the stop surfaces abut and prevent further movement when the dirt collection chambers reach the second position.

When the stop surfaces 132, 134 contact each other, the movement of the dirt collection chambers 28, 30 stops abruptly. This performs two different functions. Firstly it imparts a shock to the dirt collection chambers 28, 30 which can help to shake off dirt that has adhered to them. Secondly, it encourages the lid 32 to open. The lid 32 includes a sealing member (not shown) which engages the dirt collection chambers 28, 30, and on occasion the sealing member can stick to one of the dirt collection chambers and resist opening of the lid. When the first dirt collection chamber 28 stops (presuming the user is holding the handle 14, meaning that the first dirt collection chamber 28 moves relative to a stationary second dirt collection chamber 30), inertia in the lid 32 that has built up during movement of the first dirt collection chamber 28 causes the lid 32 to keep moving. This separates the sealing member from the dirt collection chambers 28, 30, allowing the lid 32 to open.

Whilst the stop surfaces 132, 134 preventing movement of the dirt collection chambers 28, 30 beyond the second position can be beneficial, as noted above it is also preferable for the dirt collection chambers to be movable beyond the second position so as to separate them. In order to provide both functionalities, one of the stop surfaces 134 is mounted on a pivotable catch member 138. The user can press the catch member 138 so as to selectively lift stop surface 134 out of alignment with stop surface 132 so that the stop surfaces no longer abut when the dirt collection chambers 28, 30 are in the second position. The dirt collection chambers 28, 30 can therefore be moved beyond the second position and separated from one another.

FIG. 15 shows the second assembly 68 in isolation. From this perspective the projection 140, which depresses the piston 82 to pivot the see-saw 74 to as to pivot the axial end wall 38 downwards as discussed above, is visible. This perspective also shows the mechanism by which the biasing member (not visible) urges the first and second dirt collection chambers 28, 30 towards the second position. The biasing member (not visible) takes the form of a compression spring, and is housed in a hollow cylinder 142. A piston 144 is reciprocably mounted within the cylinder, projects therefrom, and is urged downwards by the spring. When the first and second assemblies 66, 68 are in the first position, the upper wall 42 of the inlet 36 of the first separation stage 20 pushes the piston 144 upwards into the cylinder 142, compressing the spring (not visible). The restorative force from the spring pushes the piston 144, and thus the first assembly 66, downwards relative to the second assembly 68. The spring therefore acts to urge the assemblies 66, 68 towards the second position.

It will be appreciated that numerous modifications to the above described embodiments may be made without departing from the scope of invention as defined in the appended claims. For instance, in this particular embodiment the first separation stage is the primary separation stage (i.e. the separation stage furthest upstream within the dirt separator). In other embodiments however, the first separation stage may be downstream of a primary separation stage. Similarly, in this particular embodiment the second separation stage is the separation stage which is immediately downstream of the first separation stage. In other embodiments, however, a further separation stage may be positioned downstream of the first separation stage but upstream of the second separation stage.

It is to be noted that although the first guide feature has been described above as a runner, it may equally be considered to be a (relatively short) rail. Similarly, whilst both the complementary features have been described as tracks, each may equally considered to be a pair of rails (each ridge forming one of said rails).

1. A dirt separator for a vacuum cleaner, the dirt separator comprising:
a first separation stage having a first dirt collection chamber for storing dirt removed by the first separation stage; and
a second separation stage positioned downstream of the first separation stage, the second separation stage having a second dirt collection chamber for storing dirt removed by the second separation stage,
wherein:
the first dirt collection chamber is movable relative to one another between first and second positions, and
a guide feature is provided on a sidewall of the second dirt collection chamber, the guide feature being configured to guide movement of the first and second dirt collection chambers relative to one another between the first and second positions.

2. The dirt separator of claim 1, wherein two guide features are provided on one or more sidewalls of the second dirt collection chamber.

3. The dirt separator of claim 2, wherein the two guide features are provided on different sidewalls of the second dirt collection chamber.

4. The dirt separator of claim 2, wherein the two guide features are positioned on opposite sides of the second dirt collection chamber.

5. The dirt separator of claim 1, wherein the guide feature is provided on an outer surface of the sidewall.

6. The dirt separator of claim 1, wherein the guide feature contacts the first dirt collection chamber.

7. The dirt separator of claim 6, wherein the first dirt collection chamber defines at least one complementary feature, the complementary feature co-operating with the guide feature to guide the movement of the first and second dirt collection chambers.

8. The dirt separator of claim 1, wherein the first dirt collection chamber is detachable from the second dirt collection chamber by movement of the first and second dirt collection chambers beyond the second position from the first position.

9. The dirt separator of claim 1 further comprising a pair of stop surfaces which are arranged to abut when the first and second dirt collection chambers are in the second position so as to prevent the first and second dirt collection chambers from moving from the first position to beyond the second position.

10. The dirt separator of claim 9, wherein one of the stop surfaces is provided on a sidewall of the second dirt collection chamber.

11. The dirt separator of claim 9, wherein one of the stop surfaces is selectively movable out of engagement with the other of the stop surfaces so as to allow the movement of the first and second dirt collection chambers beyond the second position.

12. The dirt separator of claim 1, wherein:
the first separation stage comprises an air outlet which has an air-permeable screen,
the separator further comprises a wiping member for clearing the screen, and
the screen is movable with the first dirt collection chamber relative to the second collection chamber, and the wiping member is movable with the second dirt collection chamber relative to the first dirt collection chamber such that moving the first and second dirt collection chambers relative to each other moves the wiping member across the screen.

13. The dirt separator of claim 1 further comprising a biasing member arranged to urge the first and second dirt collection chambers towards the second position.

14. The dirt separator of claim 1, wherein the first dirt collection chamber defines a storage volume for accommodating dirt separated by the first separation stage, and the second dirt collection chamber is positioned outside of the storage volume.

15. A vacuum cleaner comprising a dirt separator, the dirt separator comprising:
a first separation stage having a first dirt collection chamber for storing dirt removed by the first separation stage; and
a second separation stage positioned downstream of the first separation stage, the second separation stage having a second dirt collection chamber for storing dirt removed by the second separation stage,
wherein:
the first dirt collection chamber is movable relative to one another between first and second positions, and
a guide feature is provided on a sidewall of the second dirt collection chamber, the guide feature being configured to guide movement of the first and second dirt collection chambers relative to one another between the first and second positions.
